(19) United States
(12) Patent Application Publication
(10) Pub. No.: US 2016/0342753 A1
(43) Pub. Date: Nov. 24, 2016

(54) METHOD AND APPARATUS FOR HEALTHCARE PREDICTIVE DECISION TECHNOLOGY PLATFORM

(71) Applicant: Starslide, Daytona Beach Shores, FL (US)

(72) Inventor: G. Landon Feazell, Ponce Inlet, FL (US)

(21) Appl. No.: 15/136,974

(22) Filed: Apr. 24, 2016

Related U.S. Application Data
(60) Provisional application No. 62/152,543, filed on Apr. 24, 2015.

(51) Int. Cl. G06F 19/00; G06N 7/00; G06N 99/00

(52) U.S. Cl. CPC G06F 19/345; G06N 99/005; G06N 7/005; G06F 19/322

(57) ABSTRACT

The present disclosure relates to methods and apparatus for evaluating medical care performance, wherein the performance may be rated as the success of the outcome to the patient and as the quality of medical care provided by an institution. More specifically, the present disclosure presents a method and apparatus for aggregating and correlating unstructured data related to patients, medical institutions, and medical procedures, which may allow for more effective management of a patient's health.

### CROSS REFERENCE TO RELATED APPLICATIONS

The present application claims priority to U.S. provisional Patent Application Ser. No. 62/153,543, entitled SYSTEM FOR QUANTIFICATION OF HEALTH CARE QUALITY AND PREDICTIVE HEALTHCARE VALUE, QUALITY AND OUTCOMES OF HEALTHCARE OF AN INDIVIDUAL PATIENT, the contents of which are relied upon and incorporated herein by reference.

### FIELD OF THE DISCLOSURE

The present disclosure relates to methods and apparatus for gathering information related to patient health and patient care and predicting medical care performance. More specifically, the present disclosure presents methods and apparatus for aggregating and correlating data related to patients and patient care in order to effectively manage a patient's health.

### BACKGROUND OF THE DISCLOSURE

Traditionally, an individual may visit a doctor with a specific set of symptoms, and the doctor will attempt to diagnose the patient based on provided information and designated testing. This process is inherently based on incomplete information, as the patient answers directed questions from the doctor.

Currently procedures are typically tracked according to a fee code and an occurrence of an event but not the quality of the event or the outcome of the event as far as satisfaction of a patient involved. The current medical research, bioinformatics and clinical decision support enterprises cannot keep pace with the clinical information needs of patients, physicians, clinicians, administrators and policy makers, much less the innovators of new diagnostic tools, treatment interventions, pharmaceuticals, medical devices, remote monitoring devices, and mobile applications to support transitions to new medical care models, value-based purchasing, population health. All too frequently, medical research focuses on narrow research questions to avoid complexity and to address oversight agency concerns. Such medical research by design does not include exposure to a multitude of variables and disparate conditions. On the contrary, variables and changed conditions are purposefully limited. What is needed therefore are methods and systems to broaden both the patients and the health care practitioner's knowledge of relevant variables and conditions.

### SUMMARY OF THE DISCLOSURE

Accordingly, the present invention provides an integrated system of methods related to individual (patient) health and patient care and apparatus for performing methods, combining strategic analytics from scientific metrics and unsupervised machine learning. The system of methods includes integrated clinical measurement, analytics, decision support, remote monitoring and user-defined applications integrating methods for structured and unstructured data collection and analytics comprised of strategic scientific metrics and algorithms merged with hidden pattern detection from unsupervised learning and digital technology operating on a unified database formatted in the DaTA© template of meFactors© calibrating performance and outcomes measurement as an experiential learning platform for advanced analytics to achieve optimal clinical processes (OCP's), disease management and wellness for value-driven optimal (“precision”) health.

In some aspects, the present invention provides methods for tracking variables related to patient health and patient care and apparatus for performing the methods. In some embodiments, patient variables may be related to a record of performance of a medical institution to provide a more informed method of diagnosing and treating a patient.

The methods include integrated clinical measurement, analytics, decision support, remote monitoring and user-defined applications system of methods comprised of strategic scientific metrics and algorithms merged with structured and unstructured hidden pattern detection from unsupervised learning and digital technology operating on a unified database formatted in the DaTA© template of meFactors© calibrating performance and outcomes measurement as an experiential learning platform for advanced analytics to achieve optimal clinical processes (OCP's), disease management and wellness for value-driven optimal (“precision”) health.

Unstructured data analysis may determine hidden patterns of seemingly unrelated variables involved in administration of healthcare. Although healthcare typically includes large databases, unstructured data already is the vast majority of data stored. Unstructured data analysis includes algorithms to process relationships with data outside of traditional structured data and also uses platforms such as IBM Watson to determine relationships between structured data and structured data; structured data and unstructured data; and structured data and structured data. The present disclosure includes methods and processes for applying unstructured data analysis to defined groups of patients and to single patients via meFactors.

Apparatus and devices are used to collect patient data, such as biometric data, genetic data, demographic data and other patient specific data. The patient data is correlated with a patient condition and one or more suggested procedures. Institutional data related to the suggested procedures is analyzed to provide treatment alternatives and facilitate healthcare options for the patient. In some aspects, a smart watch, or other individually worn digital acquisition devices, such as for example ONE OR MORE OF: A FitBit™, a Samsung Gear device or other Android device and the Apple iWatch may be used to collect and transmit patient data. Other embodiments may include remote monitoring devices and patient engagement devices to collect and transmit data. Data may be aggregated by a user, such as, for example via a personal computing device, or via a centralized server accessible via a communications network, such as the Internet.

Healthcare provider and/or medical institution data may also be collected and processed to predict an anticipated outcome of a procedure, and more specifically a predicted outcome of a procedure if performed by a particular medical facility, a particular care giver, and at a particular scheduled time. Health care provider information may include PQRS data typically gathered for provision to a government agency. PQRS data may be aggregated, analyzed and used for patient care, including, value, quality and outcomes and predictive healthcare of an individual patient.

Structured and unstructured queries may access the biometric data, genetic data, demographic data and other patient related data sources and combine it with data descriptive of a medical facility, health care staff, procedures, scheduling and other data to support health care related decisions.

Historical analysis such as past performance of healthcare personnel, performance of scheduling variables, use of particular supplies, use of particular pharmaceuticals, use of particular prosthetics or other medical devices and other data may be match with real time data of times in stock, or otherwise available, at a particular medical facility and scheduling options of facilities and staff to map a predicted outcome. In addition, unstructured queries which match seemingly unrelated data items may be used to further predict an outcome of a medical procedure performed on a particular patient under particular circumstances.

According to the present invention, Care Plans are extensions of actionable insights gained from continuous optimal clinical processes analytics; meFactors© calibrate performance and outcomes analytics are used for personal wellness and fitness personal performance as well as physician/clinician performance for optimal outcomes.

Personalized health methods integrate patient-generated data from remote monitoring devices, sensors and wearables with provider-generated data calibrated by meFactors©. Unsupervised machine learning identifies data for inclusion in summarized data formats with algorithms for predictive modeling and data that is displayed with analytics from the novel database of PHR/PMR for care plans relies on layered health information system (HIS) similar to filters in GIS systems. Omics and biomarkers may be used for advanced targeted precision and molecular therapeutics. Experiential learning platforms implement methods for disease interception and preventive personalized and provider interventions.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates a general patient diagnosis and treatment flowchart of process steps.

FIG. 2 illustrates an exemplary data flow and decision-making chart associated with methods of the present invention.

FIG. 3 and FIG. 3A illustrate exemplary relationships between method steps and potential users involved in the methods steps of the present invention.

FIG. 4 illustrates aspects of controller hardware useful for implementing the present invention as a block diagram.

FIG. 5 illustrates an exemplary processing and interface system.

FIG. 6 illustrates a block diagram of an exemplary embodiment of a mobile device.

FIG. 7 illustrates a block diagram of basic elements that may be considered in implementations of the present invention.

FIG. 8 illustrates an exemplary learning platform involved in some implementations of the present invention.

### DETAILED DESCRIPTION

The present disclosure provides generally for methods and associated apparatus for collecting, aggregating and correlating unstructured data in order to facilitate health care decisions. Apparatus used to collect data may include one or more of: biometric devices, scanners, global position system (GPS) units or other geolocation devices, imaging systems, cameras, user interactive processing devices and other automated devices for collecting data which may ultimately be organized in order to assist in making decisions relating to a health care procedure. In addition, health care provider information may be collected and aggregated related to procedures provided by medical institutions, health care practitioners, facilities and the like. Health care provider information may include staff statistics; number of hours worked; number of procedures completed; outcomes of procedures; type and brand of equipment used; type and brand of supplies used; timing of a health care procedure or related activities; day of week of a health care procedure or related activities; day of year of a health care procedure or related activities, support staff for a health care procedure or related activities; insurance provider, type of insurance plan, and almost any information that may be collected, monitored and/or aggregated which is directly or indirectly related to a healthcare procedure.

The methods and apparatus described herein may be useful for those involved in Health Data Science, Population Health, Enterprise Data Management, Real-Time Point of Care Patient Management (with concurrent Quality Management), Precision Health provision, Individual Health & Wellness (monitoring & care/coaching), Patient-Centered Health “Precision Medicine”, Disease Interception, Pharmaceutical Development, Medical Device design and manufacture, and healthcare Quality & Value Reporting. Essentially by those for whom Healthcare Value=Cost+Quality. According to some embodiments of the present invention, outcomes metrics are different that performance metrics. In addition, unsupervised learning (machine learning) may look for relationships in data sets that may appear unrelated, such as where have you traveled in the past twenty four months with medical symptoms.

In the following sections, detailed descriptions of examples and methods of the disclosure will be given. The description of both preferred and alternative examples though through are exemplary only, and it is understood that to those skilled in the art that variations, modifications, and alterations may be apparent. It is therefore to be understood that the examples do not limit the broadness of the aspects of the underlying disclosure as defined by the claims.

### GLOSSARY

Biological Communication: as used herein shall refer to a Biometric Measuring Device situated to measure one or more biological aspects of a patient. Biological aspects may include a chemical reading, such as a level of a blood constituent, chemical analysis of blood, urine, stool, ad/or saliva. Biological aspects may also include an electrical reading such as a heart rate, EEG, ECG, QEEG or other electrical based reading. Biological aspects may further include an image of a patient, such as an MRI, a sonogram or a CAT scan.

Health Care Practitioner: as used herein shall mean an individual engaged in the provision of healthcare, such as, for example, one or more of: a medical doctor, physician's assistant, nurse practitioner, nurse, medical technician, and a hospice worker.

MeFactors: as used herein refers to factors associated with an individual which may translate into health risk factors. In preferred embodiments, MeFactors include data and/or extrapolations based upon data, from monitoring devices such as, for example, data from one or more of: a heartrate monitor, a smartphone or other device that tracks movement, a glucose monitor, a pace maker, a sleep monitor or almost any other device that provides biometric data.

Medical Institution: as used herein refers to an organization engaged in the provision of medical care.

Medical Procedure: as used herein refers to any action from a medical institution in response to a health condition, existing or anticipated. For example, a medical procedure may comprise an operation, a treatment plan, vaccination, or a drug prescription.

Outcome: as used herein refers to the results of a medical procedure, wherein the results may comprise a success rating, long term health status, subsequent medical care related to the medical procedure.

Situational Factors: as used herein refers to objective characteristics of a medical procedure, such as, time designation, atmospheric conditions, room temperature, or medical staff.

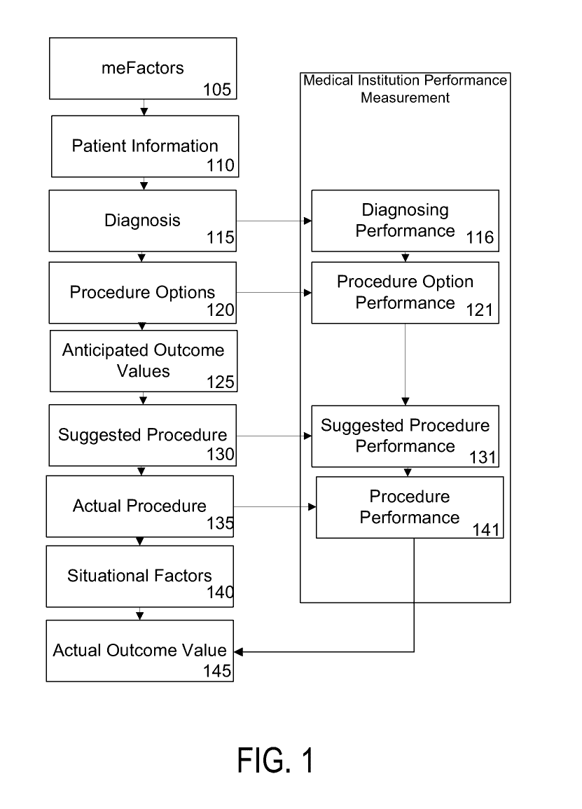

Referring now to FIG. 1, a flowchart with steps that may be enacted according to some embodiments of the present invention which generate and aggregate patient data and facilitate a healthcare decision. The data generation and aggregation may generally begin with a collection of data pertaining to a patient, diagnosis of a health condition and progression to a decision to perform a procedure.

At 105, meFactors are gathered. As defined above, meFactors may include, by way of non-limiting examples, a family history, medical history including prior medical procedures and outcomes, prior medical diagnoses, or information received from other sources. In preferred embodiments, MeFactors include data and/or extrapolations based upon data, captured with a biometric measuring device in biological communication with a patient such as, for example, data from one or more of: a heartrate monitor, a smartphone or other device that tracks movement, a glucose monitor, a pace maker, a sleep monitor, a blood constituent sensor, a VOX sensor, or almost any other device that provides biometric data.

As such, biometric and personal data may also include lab results of one or more of blood, urine, saliva, body tissue or other cells. As such data collection may be received and aggregated from a variety of devices that provide one or both of biometric data, lab data and image data related to a patient.

At method step 110, direct patient information may be collected, wherein a medical event may initiate collection. In some embodiments, a staff member, nurse, or doctor from a medical institution may prompt a patient for the information. In some aspects, a patient may directly input answers to computer-presented queries.

At method step 115, a diagnosis may be determined based on one or both of patient information and meFactors. According to the present invention, a diagnosis may be based upon one or both of the opinion of a Health Care Practitioner and a statistical quantification of meFactors of other patients combined with confirmed conditions of other patients.

At method step 120, potential medical procedures may be identified as treatments options for the diagnosis. Similar to the diagnosis, according to the present invention, the potential medical procedures may be based upon one or both of the opinion of a Health Care Practitioner and a statistical quantification of meFactors of other patients, combined with confirmed conditions of other patients as well as statistical analysis of Procedure Performance and Actual Outcome Values of other patients.

At method step 125, anticipated outcome values may be assessed for one or more selected potential medical procedures. Anticipated outcome values may be derived based upon statistical analysis of the one or more selected potential medical procedures and quantification of meFactors of other patients, combined with confirmed conditions of other patients and statistical analysis of Procedure Performance and Actual Outcome Values of other patients. Anticipated outcome values may also include Procedure Performance of one or more anticipated Health Care Providers including Health Care Practitioners and Health Care Institutions and data related to same.

At method step 130, a suggested medical procedure may be identified and presented. According to the present invention, a suggested medical procedure may be suggested by one or both of a Health Care Practitioner and a computerized system receiving biometrics, image data and lab results of a patient. At 135, the medical procedure may be scheduled and completed. Data relating to a time of day of the procedure, a time of week, a time of year may be collected. In addition, factors such as a length of time between diagnosis and completion of the procedure and time of scheduling and completion of the procedure may be tracked. Other factors, such as distance travelled to have the procedure completed may also be tracked. At 140, situational factors of the medical procedure may be collected. Situational factors may include almost any details related to the completed procedure. Some exemplary situational features may include meFactors at the time of the procedure.

At method step 145, an actual outcome value of the completed medical procedure may be assessed. The Actual Outcome Value may be based upon meFactors following the procedure as well as subjective input from one or both of the patient and a Health Care Practitioner. In some embodiments, a medical institution may be evaluated for its performance at various action points.

At method step 116, the medical institution may be rated for its diagnosing performance, wherein the rating may be based on accuracy or relevance to patient information, for example. In some aspects, the rating may be relative, wherein the rating compares a particular diagnosis to other diagnoses in similar cases. A relative rating may indicate similarity to other medical institutions as well as the creativity of the diagnosis, which may be preferable to patients who may have exhausted typical diagnosis treatments.

At method step 121, the medical institution may be rated for its procedure option performance, wherein the rating may be based on the thoroughness and relevance of the procedure options. At 131, the medical institution may be rated for its suggested procedure performance, wherein the rating may be based on assessed anticipated outcome values or relatively to other suggested procedures for similar diagnoses, meFactors, and patient information.

At method step 141, the medical institution may be rated for its medical procedure performance. The rating may be based on a variety of factors, such as, for example, the anticipated outcome value compared to the actual outcome value and situational factors. In some aspects, some situational factors may not necessarily affect the rating, such as time of the year or day, amount of sunlight, brand of surgical tools, or room number. Aggregating the situational factor data may indicate that a situational factor should increase or decrease a procedure performance rating. For example, a particular brand of surgical tools may be associated with poor quality, and the use of that brand may result in a lower rating. As another example, the aggregated data may indicate that Wednesday morning procedures for a particular medical institution or region tend to have substantially higher outcome values.

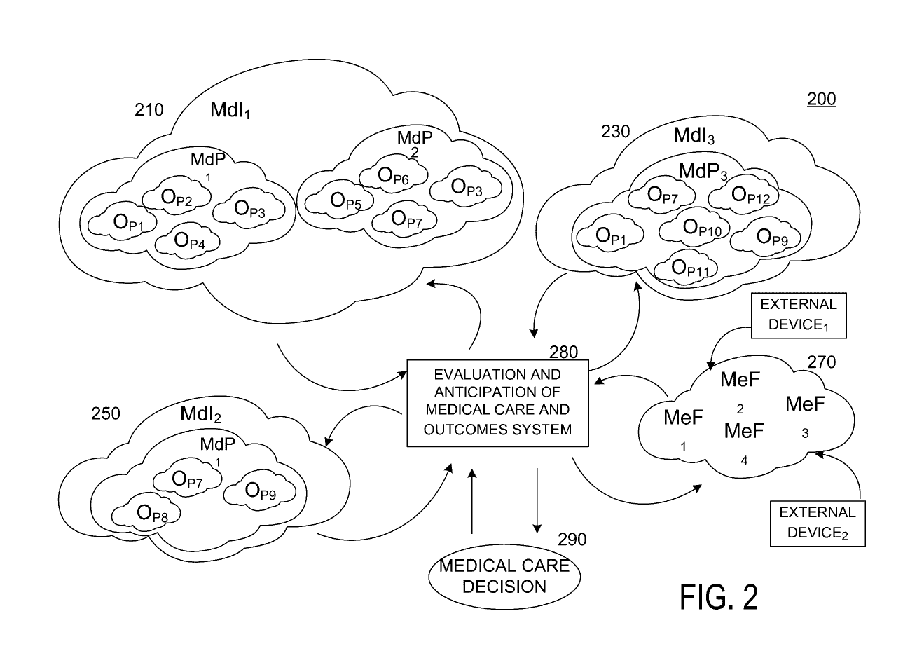

Referring now to FIG. 2, a data flow and decision-making chart 200 is illustrated. In some embodiments, medical institutions (MdI) may perform one or more medical procedures (MdP) on one or more patients (P). In some aspects, the outcomes (O) for each medical procedure for each patient may be separately recorded. In some implementations, an individual may be evaluated, and meFactors (MeF) may be extracted, extrapolated, collected, and combinations thereof. In some embodiments, external devices may contribute information that may be used to develop meFactors for an individual. In some aspects, meFactors may be collected for a patient and provided in conjunction with the outcome from a medical procedure.

In some aspects, collected data may be sorted by perspective. For example, data from a procedure may be collected regarding the patient, the medical institution, and situational factors. In some embodiments, at least some of the collected data may comprise unstructured information, wherein the collected data may not be organized in a predefined manner. Collecting data as unstructured information may allow the system to identify patterns and data correlations that may not be expected, understood, or intended.

In some aspects, there may be a mix of structured and unstructured or the collected data may be semi-structured, wherein the collected data may be loosely organized. For example, the situational factors may be collected as unstructured information, and patient and medical institution data may be collected as semi-structured data, which may create surprising correlations between situational factors and medical procedures.

As an illustrative example, the suggested medical procedure may generally be angioplasty to treat heart disease. Further details may be suggested based on meFactors, such as the type of cardiac catheter and artery entry point. The meFactors may be combined with medical procedure data to extrapolate a suggested medical institute or institutes, such as one that may specialize in angioplasty or one that routinely performs the medical procedure.

In some embodiments, the suggested medical procedure may specify situational factors that may lead to the highest outcome value. The beneficial situational factors may be extrapolated from medical procedure data and meFactors. For example, the suggested medical procedure may identify the manufacturer of the catheter, the medical staff, and hospital room, preparatory medication (i.e. for relaxation and for initial anesthetic). These situational factors may be suggested because the medical procedure performed on patients with the same or similar meFactors resulted in high outcome values. The reason for the correlation between the situational factors and the outcome values may not be apparent or necessary.

In some aspects, the information collected from the various medical institutions may develop a decision-making system, wherein application of meFactors for an individual to the decision-making system may suggest one or more medical care decisions. In some embodiments, the decision-making system may provide anticipated outcomes for medical care decisions associated with a medical procedure, which may support the suggested medical care decision.

In some embodiments, an individual's biometrics may be tracked, such as through medical devices in the procedure room, prescribed medical procedure devices, or general devices. For example, biometrics may be collected from a procedure room heart monitor, a pacemaker, and a sleep tracking smartphone application. Other biometric meFactors may include blood constituent measurements, blood glucose measurements, and VOX measurements.

In some aspects, the suggested medical procedure may be as simple as eight hours of sleep, an Epsom salt bath, eating additional fiber, or adding two thousand steps of walking per day. In some embodiments, the suggested medical procedure may include diagnostic tests, such as blood tests, or health monitoring through use of a medical device, such as a glucose monitor.

In some embodiments, the suggested medical procedure may be transmitted to one or more of the patient, medical institution, doctor, or other medical authority. In some aspects, multiple suggested medical procedures may be transmitted, wherein the procedures may be ranked by the expected outcome values. The recipients may review the suggested medical procedure or procedures and determine which option the patient may accept. In some implementations, a suggested medical procedure may be accepted, wherein the acceptance may be transmitted to the system and initiate the procedure.

In the illustrative example, the accepted medical procedure may be transmitted to the selected medical institution. In some embodiments, the accepted medical procedure may be transmitted to a medical device, which may implement one or more aspects of the medical procedure. In the illustrative example, the type and dose of the numbing medication may be transmitted along with identification information to a syringe that may allow a nurse to administer the appropriate drug delivery.

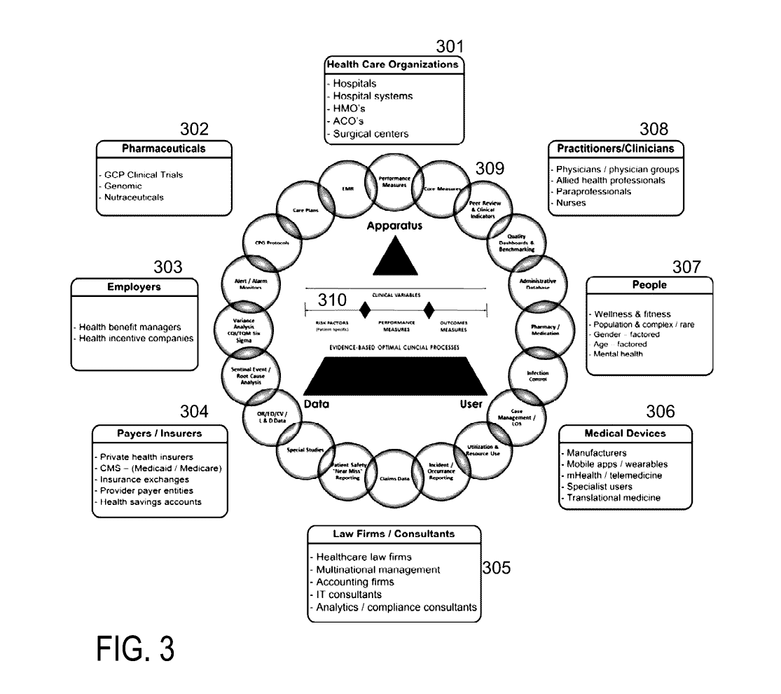

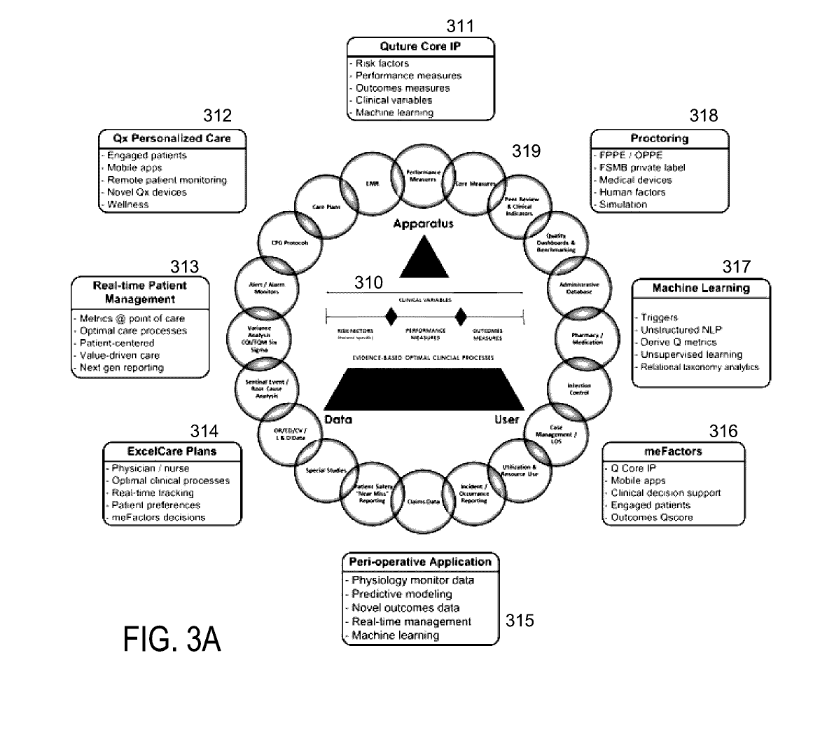

Referring now to FIG. 3, a series of interconnected exemplary implementations of the present invention are illustrated. Automated apparatus 310, as described more fully below, provide functionality, such as, one or more of: machine reading and learning, big data analytics and artificial intelligence technologies may be made integral to the strategic combination of integrated building blocks for distinct uses (business value propositions/business cases) in a systematic method of relationships.

The automated apparatus 310 may receive input from data conduits 309. The data conduits 309 may also be generators of data. Typically data will be conveyed in a digital format. Structured data may include textual and annotation data. Unstructured data may include almost any format of data that may be transposed into a digital representation of the data. Accordingly, unstructured data may include, by way of non-limiting example, on or more of; image data, biological measurements, geospatial designation, a time value (relative or fixed), audio, video and other representations of a physical attributes or an action.

Sources of data may include, for example, semantic natural language processes (NLP) tools may include QualOptima v1.3 “triggers” required for compliance with Joint Commission FPPE-OPPE Standards embedded electronically into structured and unstructured data capture, aggregation and integration into the Qualytx database. Triggers (key word searches) may identify sub-optimal outcomes or clinical process variables for OPPE or potential fraud & abuse analytics. Clinical indicators of sub-optimal outcomes for medical record review in the peer review application may be used. QualOptima v1.5 proctoring application to evaluate current clinical competence by electronic clinical data analytics in an educational and clinical process simulation method.

Signal detection for adverse outcomes with analytics in a framework to assess which of the many dimensions of data are important and which can be ignored. QualOptima v1.7 and 2.0 electronic data capture of specific defined numerator and denominators with exclusions/exceptions for performance and outcomes metrics and analytics. Hospital Inpatient Quality Reporting (Hospital IQR) of quality measures for financial incentives to receive full update to payment rates for the ensuing year—Reporting Hospital Quality Data for Annual Payment Update (RHQDAPU) program. Hospital Focused & Ongoing Professional Practice Evaluations (FPPE-OPPE) medical specialty performance & outcomes metrics in the ACGME framework for Joint Commission Accreditation pursuant to Standards. Hospital programs to reduce unnecessary readmissions, hospital-acquired conditions (HAC's), and “never events” to avoid payment penalties.

Physician Quality Reporting System (PQRS) may include physician relative-value metrics for distribution of payments in Accountable Care Organizations (ACO's) and Medical Homes. Machine learning tools for users may include QualOptima v1.3 machine learning employing advanced mathematical and computational systems to reveal information from performance and peer review databases, as well as unsupervised learning and graph analytics to identify hidden patterns and to understand relationships. QualOptima v1.5 proctoring application database machine learning employing advanced mathematical and computational systems to reveal information from performance and peer review databases, as well as unsupervised learning and graph analytics to identify hidden patterns and to understand relationships.

The apparatus may include, advanced mathematical and computational systems, such as 310 QualOptima v1.7 and v2.0 machine learning to reveal information from outcomes relying on clinical variables related back by algorithms for personalized and clinical performance databases, as well as unsupervised learning and graph analytics to identify hidden patterns and to understand relationships. Machine learning and deep learning technologies for image analytics, such as radiology images for diagnostic characteristics. Machine learning and deep learning technologies for healthcare customers (and internal use added to below) using social media [nearly ⅓ adults use social media for health conversations. Machine learning tools for internal use for knowledge, marketing and consulting may comprise machine learning from intra-operative physiologic monitors with direct data feeds into QualOptima integrated into the peri-operative outcomes application. Machine learning from patient-generated data in remote monitoring devices and enabled patient databases to learn from daily health experiences.

Machine learn from telemedicine databases generated in population health databases for disease classification and substrate phenotypes in chronic and acute illnesses, cancer, elderly, mental health and wellness populations. Machine learning from public databases (such as AHRQ/HCUP) to identify low-performing and high-performing hospitals and physician groups to identify potential customers to improve outcomes. Machine learning from public databases to phenotype hospitals and physician groups, defining groups that have similar profiles and characteristics using potentially harmful (and/or expensive) medications or treatment modalities evaluating how they respond to new clinical and/or financial information as rapid learning organizations. Machine learning from massive data collections to classify hospitals based jointly on their financial and clinical performance.

Machine learning from international medical literature to continuously identify performance and outcomes metrics and personal risk and fitness/wellness factors for the QualOptima library. Machine learning from international literature to continuously determine optimal clinical processes of care. Participation in international dynamic platforms for presenting, updating, evaluating and analyzing results from machine learning and big data tools, such as ZENODO (Geneva).

Other sources of data that may be used in machine learning and recipients of output generated by machine learning include, by way on nonlimiting example, one or more of: health care organizations 301; pharmaceutical related data 302; employers 303; payers and/or insurers; law firms and health consultants 305; medical device related data 306; people 307 and health care practitioners 308.

Referring now to FIG. 3A, a functional diagram illustrates automated apparatus 310 and data conduits 309, as well as sources of structured and unstructured data, which may also display results of data analysis. The sources of structured and unstructured data, may include, by way of non-limiting example: Qx personalized Care apparatus; Patient Management systems 313; Excel Care Plans 314; perioperative Applications and devices that run the processes 315; meFactors 316; machine learning output 317 and proctoring 318.

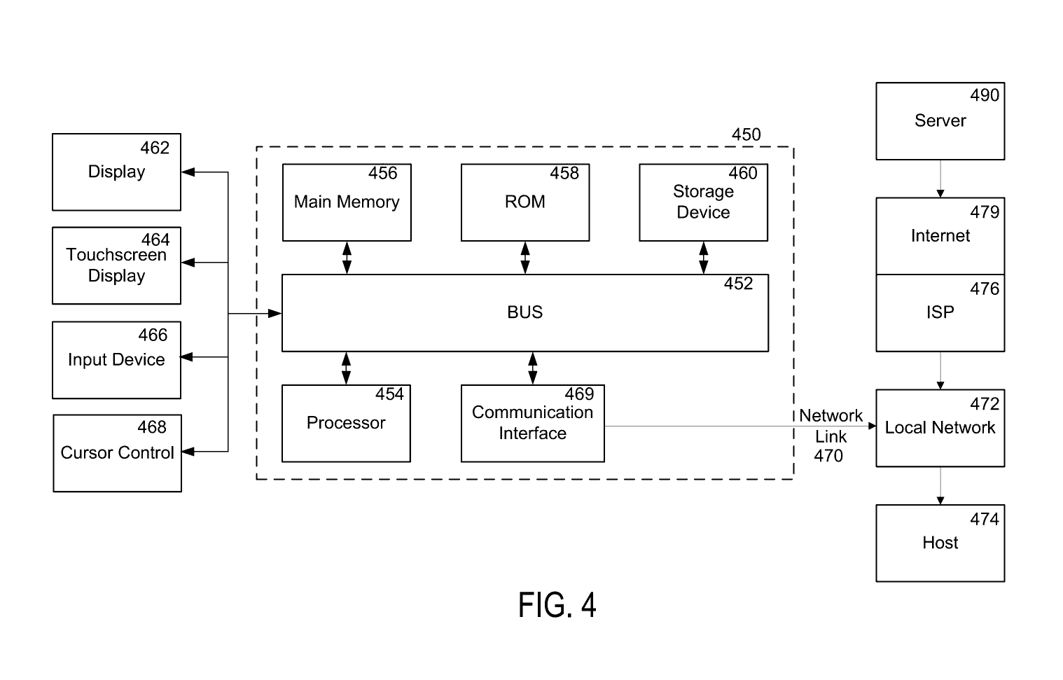

Referring now to FIG. 4, additional aspects of controller hardware useful for implementing the present invention are illustrated as a block diagram that includes a controller 450 upon which an embodiment of the invention may be implemented. Controller 450 includes a bus 452 or other communication mechanism for communicating information, and a processor 454 coupled with bus 452 for processing information.

Controller 450 also includes a main memory 456, such as a random access memory (RAM) or other dynamic storage device, coupled to bus 452 for storing information and instructions to be executed by processor 454. Main memory 456 may also be used for storing temporary variables or other intermediate information during execution of instructions to be executed by processor 454. Controller 450 further includes a read only memory (ROM) 458 or other static storage device 460.

Controller 450 may be coupled via bus 452 to a display 462, such as a cathode ray tube (CRT), liquid crystal display (LCD), plasma display panel (PDP), organic light-emitting diode (OLED), projector, or heads up display for displaying information to a computer user. An input device 466, including alphanumeric and other keys, may be coupled to bus 452 for communicating information and command selections to processor 454. Another type of user input device is cursor control 468, such as a mouse, a trackball, a touchpad, or cursor direction keys for communicating direction information and command selections to processor 454 and for controlling cursor movement on display 462. Another type of user input device is a touchscreen display 464 where a user may communicate information and command selections to processor 454 by tactile interaction with the display thereby controlling cursor movement or alphanumeric and other keys. This input device typically has two degrees of freedom in two axes, a first axis (e.g., x) and a second axis (e.g., y), that allows the device to specify positions in a plane.

Embodiments of the invention are related to the use of controller 450 for setting operational parameters relating to meFactors. According to some embodiment of the invention, meFactor parameters are defined and managed by controller 450 in response to processor 454 executing one or more sequences of one or more instructions contained in main memory 456. Such instructions may be read into main memory 456 from another computer-readable medium, such as storage device 460. Execution of the sequences of instructions contained in main memory 456 causes processor 454 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 454 for execution. Such a medium may take many forms, including but not limited to, non-volatile media, volatile media, and transmission media. Non-volatile media includes, for example, optical or magnetic disks, such as storage device 460 and 458. Volatile media includes dynamic memory, such as main memory 456. Transmission media includes coaxial cables, copper wire and fiber optics, including the wires that comprise bus 452. Transmission media may also take the form of acoustic or light waves, such as those generated during radio wave and infrared data communications.

Common forms of computer-readable media include, for example, a memory stick, hard disk or any other magnetic medium, a CD-ROM, any other optical medium, a RAM, a PROM, and EEPROM, any other memory chip or cartridge, or any other medium from which a computer may read.

Various forms of computer readable media may be involved in carrying one or more sequences of one or more instructions to processor 454 for execution. For example, the instructions may initially be carried on a magnetic disk of a remote computer. The remote computer can load the instructions into its dynamic memory and send the instructions over a distributed network such as the Internet. A communication device may receive the data on the telephone line, cable line, or fiber-optic line and use an infrared transmitter to convert the data to an infrared signal. An infrared detector can receive the data carried in the infrared signal and appropriate circuitry can place the data on bus 452. Bus 452 carries the data to main memory 456, from which processor 454 retrieves and executes the instructions. The instructions received by main memory 456 may optionally be stored on storage device 460 either before or after execution by processor 454.

Controller 450 also includes a communication interface 469 coupled to bus 452. Communication interface 469 provides a two-way data communication coupling to a network link 470 that may be connected to a local network 472. For example, communication interface 469 may operate according to the internet protocol. As another example, communication interface 469 may be a local area network (LAN) card allowing a data communication connection to a compatible LAN. Wireless links may also be implemented.

Network link 470 typically provides data communication through one or more networks to other data devices. For example, network link 470 provides a connection through local network 472 to a host computer 474 or to data equipment operated by an Internet Service Provider (ISP) 476. ISP 476 in turn provides data communication services through the worldwide packet data communication network now commonly referred to as the “Internet” 479. Local network 472 and Internet 479 both use electrical, electromagnetic or optical signals that carry digital data streams. The signals through the various networks and the signals on the network link 470 and through communication interface 469, which carry the digital data to and from controller 450 are exemplary forms of carrier waves transporting the information.

In some embodiments, Controller 450 may send messages and receive data, including program code, through the network(s), network link 470 and communication interface 469. In the Internet example, a server 490 might transmit a requested code for an application program through Internet 479, ISP 476, local network 472 and communication interface 469.

Processor 454 may execute the received code as it is received, and/or stored in storage device 460, or other non-volatile storage for later execution. In this manner, controller 450 may obtain application code in the form of a carrier wave.

Access devices may include any device capable of interacting with controller or other service provider. Some exemplary devices may include a mobile phone, a smart phone, a tablet, a netbook, a notebook computer, a laptop computer, a wearable computing or electronic device, a terminal, a kiosk or other type of automated apparatus. Additional exemplary devices may include any device with a processor executing programmable commands to accomplish the steps described herein.

A controller may be a programmable board such as an arduino board, and/or one or more of: personal computers, laptops, pad devices, mobile phone devices and workstations located locally or at remote locations, but in communication with the system. System apparatus can include digital electronic circuitry included within computer hardware, firmware, software, or in combinations thereof. Additionally, aspects of the invention can be implemented manually.

Apparatus of the invention can be implemented in a computer program product tangibly embodied in a machine-readable storage device for execution by a programmable processor and method actions can be performed by a programmable processor executing a program of instructions to perform functions of the invention by operating on input data and generating output. The present invention may be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired, and in any case, the language can be a compiled or interpreted language. Suitable processors include, by way of example, both general and special purpose microprocessors.

Generally, a processor will receive instructions and data from a read-only memory and/or a random access memory. Generally, a computer will include one or more mass storage devices for storing data files; such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EEPROM and flash memory devices; magnetic disks such as, internal hard disks and removable disks; and CD ROM disks. Any of the foregoing can be supplemented by, or incorporated in, ASICs (application-specific integrated circuits).

In some embodiments, implementation of the features of the present invention is accomplished via digital computer utilizing uniquely defined controlling logic, wherein the controller includes an integrated network between and among the various participants in Process Instruments.

The specific hardware configuration used is not particularly critical, as long as the processing power is adequate in terms of memory, information updating, order execution, redemption and issuance. Any number of commercially available database engines may allow for substantial account coverage and expansion. The controlling logic may use a language and compiler consistent with that on a CPU included in the medical device. These selections will be set according to per se well-known conventions in the software community.

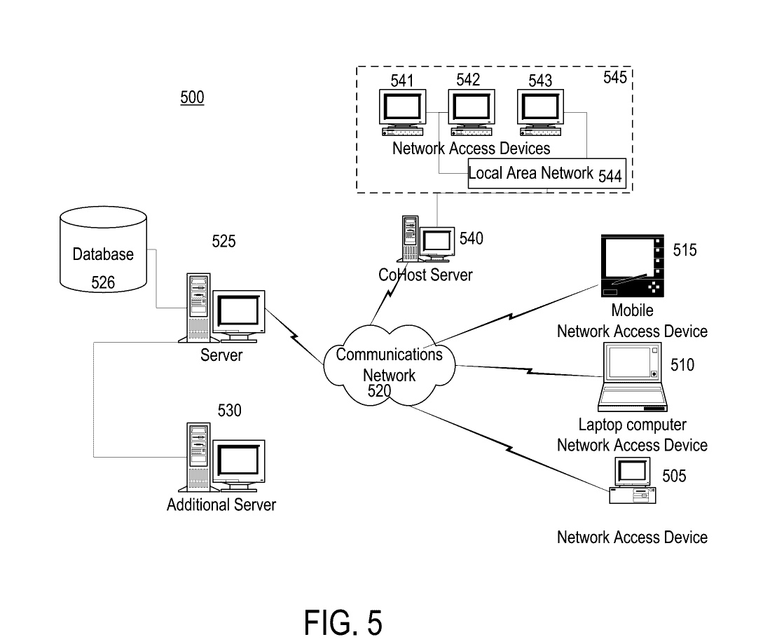

Referring now to FIG. 5, an exemplary processing and interface system 500 is illustrated that may be used in some implementations to perform the methods of the present invention. In some aspects, the methods may include network access devices 515, 510, 505, such as a mobile device 515 or laptop computer 510 may be able to communicate with an external server 525 though a communications network 520. The network access devices 515, 510, 505 may receive instructions via a platform service system embodied on an external server 525 in logical communication with a database 526, which may comprise data related to identification information and associated profile information. In some examples, the server 525 may be in logical communication with an additional server 530, which may comprise supplemental processing capabilities.

In some aspects, the server 525 and access devices 505, 510, 515 may be able to communicate with a cohost server 540 through a communications network 520. The cohost server 540 may be in logical communication with an internal network 545 comprising network access devices 541, 542, 543 and a local area network 544. For example, the cohost server 540 may comprise a payment service, such as PayPal or a social network, such as Facebook or a dating website.

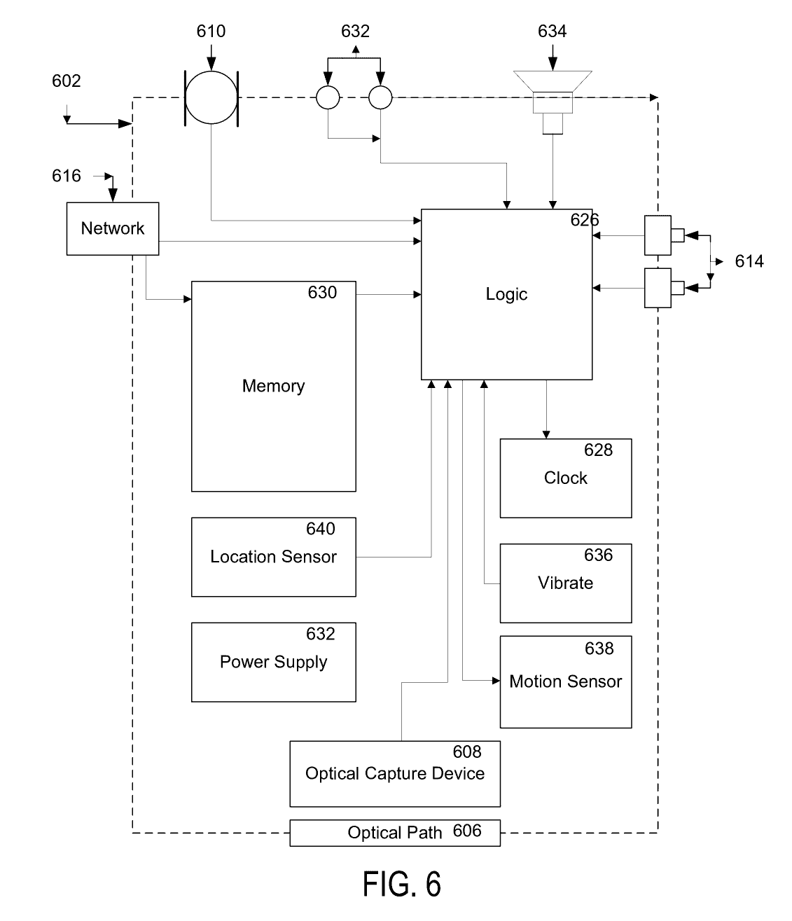

Referring now to FIG. 6, a block diagram of an exemplary embodiment of a mobile device 602 is illustrated. The mobile device 602 may comprise an optical capture device 608, which may capture an image and convert it to machine-compatible data, and an optical path 606, typically a lens, an aperture, or an image conduit to convey the image from the rendered document to the optical capture device 608. The optical capture device 608 may incorporate a Charge-Coupled Device (CCD), a Complementary Metal Oxide Semiconductor (CMOS) imaging device, or an optical sensor of another type.

In some embodiments, the mobile device 602 may comprise a microphone 610, wherein the microphone 610 and associated circuitry may convert the sound of the environment, including spoken words, into machine-compatible signals. Input facilities 614 may exist in the form of buttons, scroll-wheels, or other tactile sensors such as touch-pads. In some embodiments, input facilities 614 may include a touchscreen display. Visual feedback 632 to the user may occur through a visual display, touchscreen display, or indicator lights. Audible feedback 634 may be transmitted through a loudspeaker or other audio transducer. Tactile feedback may be provided through a vibration module 636.

In some aspects, the mobile device 602 may comprise a motion sensor 638, wherein the motion sensor 638 and associated circuitry may convert the motion of the mobile device 602 into machine-compatible signals. For example, the motion sensor 638 may comprise an accelerometer, which may be used to sense measurable physical acceleration, orientation, vibration, and other movements. In some embodiments, the motion sensor 638 may comprise a gyroscope or other device to sense different motions.

In some implementations, the mobile device 602 may comprise a location sensor 640, wherein the location sensor 640 and associated circuitry may be used to determine the location of the device. The location sensor 640 may detect Global Position System (GPS) radio signals from satellites or may also use assisted GPS where the mobile device may use a cellular network to decrease the time necessary to determine location. In some embodiments, the location sensor 640 may use radio waves to determine the distance from known radio sources such as cellular towers to determine the location of the mobile device 602. In some embodiments these radio signals may be used in addition to and/or in conjunction with GPS.

In some aspects, the mobile device 602 may comprise a logic module 626, which may place the components of the mobile device 602 into electrical and logical communication. The electrical and logical communication may allow the components to interact. Accordingly, in some embodiments, the received signals from the components may be processed into different formats and/or interpretations to allow for the logical communication. The logic module 626 may be operable to read and write data and program instructions stored in associated storage 630, such as RAM, ROM, flash, or other suitable memory. In some aspects, the logic module 626 may read a time signal from the clock unit 628. In some embodiments, the mobile device 602 may comprise an on-board power supply 632. In some embodiments, the mobile device 602 may be powered from a tethered connection to another device, such as a Universal Serial Bus (USB) connection.

In some implementations, the mobile device 602 may comprise a network interface 616, which may allow the mobile device 602 to communicate and/or receive data to a network and/or an associated computing device. The network interface 616 may provide two-way data communication. For example, the network interface 616 may operate according to an internet protocol. As another example, the network interface 616 may comprise a local area network (LAN) card, which may allow a data communication connection to a compatible LAN. As another example, the network interface 616 may comprise a cellular antenna and associated circuitry, which may allow the mobile device to communicate over standard wireless data communication networks. In some implementations, the network interface 616 may comprise a Universal Serial Bus (USB) to supply power or transmit data. In some embodiments, other wireless links known to those skilled in the art may also be implemented.

As an illustrative example of a mobile device 602, a reader may scan some text from a newspaper article with mobile device 602. The text is scanned as a bit-mapped image via the optical capture device 608. Logic 626 causes the bit-mapped image to be stored in memory 630 with an associated time-stamp read from the clock unit 628. Logic 626 may also perform optical character recognition (OCR) or other post-scan processing on the bit-mapped image to convert it to text. Logic 626 may optionally extract a signature from the image, for example by performing a convolution-like process to locate repeating occurrences of characters, symbols or objects, and determine the distance or number of other characters, symbols, or objects between these repeated elements. The reader may then upload the bit-mapped image (or text or other signature, if post-scan processing has been performed by logic 626) to an associated computer via network interface 616.

As an example of another use of mobile device 602, a reader may capture some text from an article as an audio file by using microphone 610 as an acoustic capture port. Logic 626 causes audio file to be stored in memory 628. Logic 626 may also perform voice recognition or other post-scan processing on the audio file to convert it to text. As above, the reader may then upload the audio file (or text produced by post-scan processing performed by logic 626) to an associated computer via network interface 616.

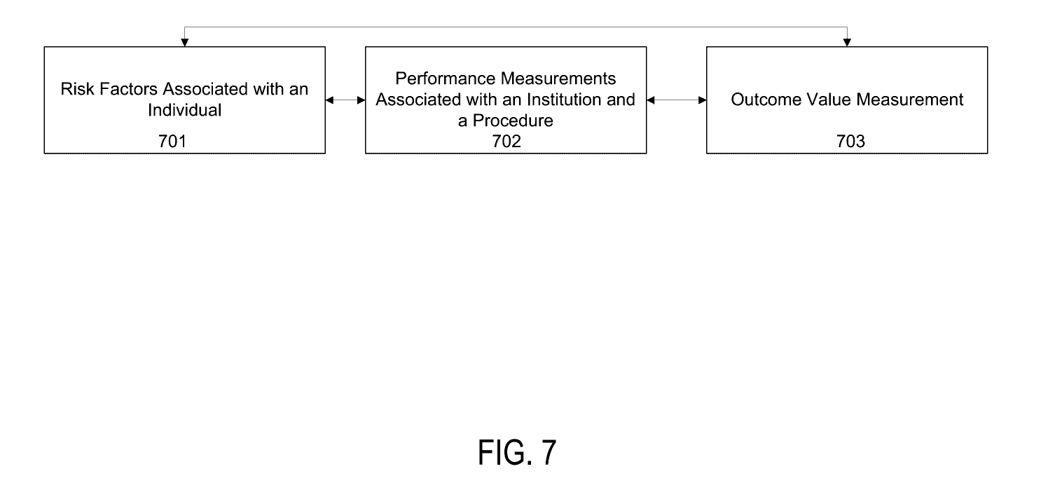

Referring now to FIG. 7, a block diagram illustrates basic elements that may be considered in some implementations of the present invention. At 701, risk factor data associated with an individual patient is collected. In some embodiments, risk factor data may be collected via one or more of: remote monitoring devices, personal biometric devices, smart watches, and patient engagement devices.

At 702 performance measurement datum associated with one or both of a health care institution and a healthcare giver are collected and aggregated. Performance measurement datum may include metrics included in PQRS reporting. Performance measurement data may also be specific to a procedure or health care regimen.

At 703 the collected data is analyzed and applied to patient care taking into consideration patient specific data and institutional and health care practitioner data. Individual patient care may be associated with an Outcome Value Measurement.

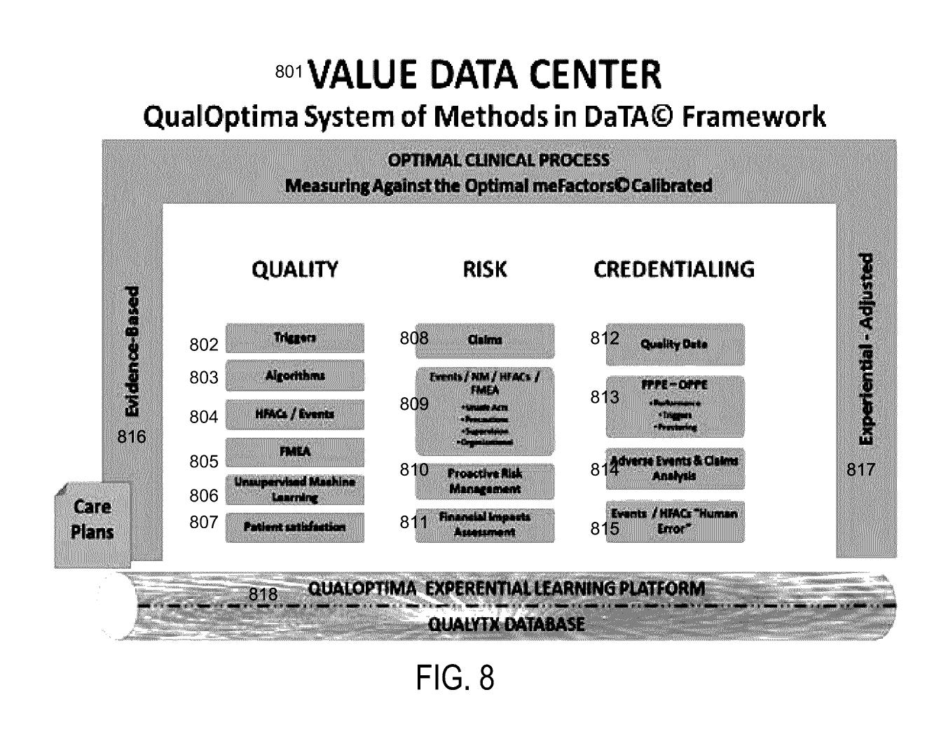

Referring now to FIG. 8, a value data center 801 may include one or more servers or a cloud based server farm and comprise automated apparatus may process data descriptive of Care Plans 816 and provide recommendations for optimal clinical processes based evidence based 816 and experientially adjusted 817 input. An experiential learning platform 818, such as, for example, a Qualoptima™ experiential learning platform, may receive as input, factors relating to Quality 802-807, Risk 808-809 and Credentialing 812-815. Other factors may also be included in some embodiments.

Quality factors 802-807 may include, by way of example, one or more of: triggers 802, algorithms 803, HFAcs/Events 804, FMEA 805, unsupervised machine learning 806 and patient satisfaction 807.

Risk factors 808-811 may include, by way of example, one or more of: claims 808, events/NM/HFCS/FMEA data 809, proactive risk management 810, and financial impact assessments 811.

Credentialing factors 812-815 may include, by way of example, one or more of: quality data 812, FPPE-OPPE data 813, adverse events and claims analysis 814 and events/HFACs data related to human error 815.

As described in the drawings and preceding description, the present disclosure includes method for facilitating a decision relating to healthcare that may be performed with automated apparatus. In some embodiments, the method include digitally polling meFactor data originating from the one or more biometric devices in biological communication with a patient and associated with a patient and receiving additional meFactor data transmitted from the network access device, wherein the meFactor data includes information that relates directly or indirectly to the health of the patient; retrieving aggregated meFactor data from a database including data descriptive of variables associated with multiple prior patients; retrieving outcome value data from a database including data descriptive of medical procedures performed by a healthcare institution on the multiple prior patients; logically aligning the meFactor data originating from the one or more biometric devices and associated with a patient, and the meFactor data transmitted from the network access device, with the outcome value data and aggregated meFactor data; and calculating statistical support for a diagnosis of a patient condition based upon the meFactor data originating from the one or more biometric devices and associated with a patient, and the meFactor data transmitted from the network access device, with the outcome value data and aggregated meFactor data.

In some embodiments, the methods may additionally include the step of logically aligning the diagnosis of a patient condition with procedure outcome data and providing statistical support for an outcome of a medical procedure treating the patient condition.

In some embodiments, the methods may additionally include the steps of accessing data descriptive of medical institution factors; logically aligning the medical institution factors with medical procedures and providing statistical support for an outcome of a medical procedure performed at the medical institution.

In some embodiments, the methods may additionally include at least a portion of the collected patient data, medical procedure data, outcome value data, and medical institution data is collected as unstructured data.

In some embodiments, the methods may additionally include collected patient data includes a patient satisfaction value. In some embodiments, the methods may additionally include logical alignment includes a structured query. In some embodiments, the methods may additionally include logical alignment includes an unstructured query. In some embodiments, the methods may additionally include the step of providing recommendations for optimal clinical processes based evidence based input. In some embodiments, the methods may additionally include the step of providing recommendations for optimal clinical processes and experientially adjusted input.

In additional aspects, the present invention includes methods for collecting and correlating unstructured health data for determining a suggested medical procedure that will result in a high anticipated outcome value, wherein the method includes the method steps of receiving first patient data from one or more external devices, wherein the patient data includes information that relates directly or indirectly to health of a current patient; receiving second patient data including input from one or more biometric devices in biological communication with the current patient; accessing a healthcare database including an aggregation of past patient data, medical procedure data, outcome value data, and medical institution data; logically identifying one or more trends supported by the aggregation of past patient data, medical procedure data, outcome value data, and medical institution data; and provide support for a diagnosis of a medical condition of the first patient based on the one or more trends identified.

The methods may additionally include the step of providing support for a suggested medical procedure based upon the trends supported by the aggregation of past patient data, medical procedure data, outcome value data, and medical institution data and transmitting the diagnosis and the suggested medical procedure.

The methods may additionally include providing support for a suggested medical institution to perform the suggested medical procedure based upon the trends supported by the aggregation of past patient data, medical procedure data, outcome value data, and medical institution data.

The methods may additionally include second patient data including input from one or more biometric devices in biological communication with the current patient includes data collected via an Apple iWatch™ device. The methods may additionally include input from one or more biometric devices in biological communication with the current patient includes data collected via a FitBit™ device.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A method for facilitating a decision relating to healthcare that may be performed with automated apparatus, the method comprising:
digitally polling meFactor data originating from the one or more biometric devices in biological communication with a patient and associated with a patient;
receiving additional meFactor data transmitted from the network access device, wherein the meFactor data comprises information that relates directly or indirectly to the health of the patient;
retrieving aggregated meFactor data from a database comprising data descriptive of variables associated with multiple prior patients;
retrieving outcome value data from a database comprising data descriptive of medical procedures performed by a healthcare institution on the multiple prior patients;
logically aligning the meFactor data originating from the one or more biometric devices and associated with a patient, and the meFactor data transmitted from the network access device, with the outcome value data and aggregated meFactor data; and
calculating statistical support for a diagnosis of a patient condition based upon the meFactor data originating from the one or more biometric devices and associated with a patient, and the meFactor data transmitted from the network access device, with the outcome value data and aggregated meFactor data.

2. The method of claim 1 additionally comprising the step of logically aligning the diagnosis of a patient condition with procedure outcome data and providing statistical support for an outcome of a medical procedure treating the patient condition.

3. The method of claim 2 additionally comprising the step of accessing data descriptive of medical institution factors;
logically aligning the medical institution factors with the medical procedure of claim 2 and providing statistical support for an outcome of a medical procedure performed at the medical institution.

4. The method of claim 1, wherein at least a portion of the collected patient data, medical procedure data, outcome value data, and medical institution data is collected as unstructured data.

5. The method of claim 4, wherein the collected patient data comprises a patient satisfaction value.

6. The method of claim 1 wherein the logical alignment comprises a structured query.

7. The method of claim 1 wherein the logical alignment comprises an unstructured query.

8. The method of claim 1 additionally comprising the step of providing recommendations for optimal clinical processes based evidence based input.

9. The method of claim 8 additionally comprising the step of providing recommendations for optimal clinical processes and experientially adjusted input.

10. A method for collecting and correlating unstructured health data for determining a suggested medical procedure that will result in a high anticipated outcome value, wherein the method comprises the method steps of:
receiving first patient data from one or more external devices, wherein the patient data comprises information that relates directly or indirectly to health of a current patient;
receiving second patient data comprising input from one or more biometric devices in biological communication with the current patient;
accessing a healthcare database comprising an aggregation of past patient data, medical procedure data, outcome value data, and medical institution data;
logically identifying one or more trends supported by the aggregation of past patient data, medical procedure data, outcome value data, and medical institution data; and
provide support for a diagnosis of a medical condition of the first patient based on the one or more trends identified.

11. The method of claim 10 additionally comprising the step of providing support for a suggested medical procedure based upon the trends supported by the aggregation of past patient data, medical procedure data, outcome value data, and medical institution data.

12. The method of claim 11 additionally comprising the step of transmitting the diagnosis and the suggested medical procedure.

13. The method of claim 10 additionally comprising the step of providing support for a suggested medical institution to perform the suggested medical procedure based upon the trends supported by the aggregation of past patient data, medical procedure data, outcome value data, and medical institution data.

14. The method of claim 10 wherein second patient data comprising input from one or more biometric devices in biological communication with the current patient comprises data collected via an Apple iWatch™ device.

15. The method of claim 10 wherein second patient data comprising input from one or more biometric devices in biological communication with the current patient comprises data collected via a FitBit™ device.
